(19) United States
(12) Patent Application Publication
(10) Pub. No.: US 2012/0101869 A1
(43) Pub. Date: Apr. 26, 2012

(54) MEDIA MANAGEMENT SYSTEM

(76) Inventors: Robert Manganelli, Plantation, FL (US); Natalie De Marco, Plantation, FL (US)

(21) Appl. No.: 12/911,094

(22) Filed: Oct. 25, 2010

(51) Int. Cl. G06Q 10/00; G06F 17/30

(52) U.S. Cl. 705/7.23; 707/825; 707/E17.005; 705/7.35; 705/400

(57) ABSTRACT

A media management system including a media storage unit which stores a plurality of media files, a media project information unit that includes a plurality of media projects and that associates at least one media file in the media storage unit with a media project in the media project information unit, a proposal unit that determines the cost to produce a media project based on the media files associated with the media project.

### FIELD OF THE INVENTION

This invention relates to the production of media such as movies, art, music and fashion designs. Specifically, this invention relates to the management of the creation and production of media.

### BACKGROUND OF THE INVENTION

Media production is presently conducted in a very piecemeal manner with numerous different entities performing different tasks in isolation. In addition, creators of new media have a very difficult time soliciting feedback from other parties. Due to the nature of media production, many creators of media have no outlet for their media. In addition, parties interested in different media have a difficult time locating new media.

These deficiencies are most evident in the movie production industry where media creators have a very difficult time generating feedback on concepts related to new movies. This results in a large lag time between the conception and completion of the media project which hurts profitability, efficiency, narrative and marketing potential.

In addition, media producers, audiences, movie studios and investors expend large amounts of time and money trying to locating new movie projects for investments and production.

A need exists for a system that will allow media producers to solicit feedback on new media from others and to also give parties interested in investing in the media a simplified way of viewing and investing in a plurality of media projects.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment consistent with the present invention includes a media management system including a media storage unit which stores a plurality of media files, a media project information unit that includes a plurality of media projects and that associates at least one media file in the media storage unit with a media project in the media project information unit, a proposal unit that determines the cost to produce a media project based on the media files associated with the media project.

In another embodiment consistent with the present invention, the media storage unit stores both original media files and edited media files.

In another embodiment consistent with the present invention, a registration unit grants user's access to view and edit media files associated with a media project.

In another embodiment consistent with the present invention, the proposal unit associates a category for each media project based on the content of the media files associated with each media project.

In another embodiment consistent with the present invention, the proposal unit associates subcategories for each media project based on the content of the media files associated with each media project and the category associated with the media project.

In another embodiment consistent with the present invention, the proposal unit generates a list of aspects of the media project based on the category and sub-category associated with the media project.

In another embodiment consistent with the present invention, the proposal unit generates a request for proposal to produce the media project based on the aspects of the media project.

In another embodiment consistent with the present invention, the media storage unit stores text documents, and the media project information unit associates each text document with at least one media file associate with the media project in the media storage unit.

Another embodiment consistent with the present invention includes a method of managing media production including the steps of storing a plurality of media files in a media storage unit, creating a media project in a media project information unit, associating at least one media file in the media storage unit with a media project in the media project information unit, determining the cost to produce a media project based on the media files associated with the media project.

In another embodiment consistent with the present invention, the media storage unit stores both original media files and edited media files.

In another embodiment consistent with the present invention, the method includes the step of granting users access to view and edit media files associated with a media project by a registration unit.

In another embodiment consistent with the present invention, the proposal unit associates a category for each media project based on the content of the media files associated with each media project.

In another embodiment consistent with the present invention, the proposal unit associates subcategories for each media project based on the content of the media files associated with each media project and the category associated with the media project.

In another embodiment consistent with the present invention, the proposal unit generates a list of aspects of the media project based on the category and sub-category associated with the media project.

In another embodiment consistent with the present invention, the proposal unit generates a request for proposal to produce the media project based on the aspects of the media project.

In another embodiment consistent with the present invention, the media storage unit stores text documents, and the media project information unit associates each text document with at least one media file associate with the media project in the media storage unit.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a block diagram of a media management system suitable for use with the methods and systems consistent with the present invention.

FIG. 2 shows a more detailed depiction of computer.

FIG. 3 depicts a flow diagram illustrating exemplary steps by the media management unit for creating a media project.

FIG. 4 depicts one embodiment of a user web page that is consistent with the present invention.

FIG. 5 illustrates a method of managing a media project consistent with the present invention.

FIG. 6 illustrates a method of managing investments in a media project consistent with the present invention.

FIG. 7 illustrates one embodiment of a method of soliciting and tracking an investment in a media project consistent with the present invention.

FIG. 8 illustrates one embodiment of a method of soliciting proposals to produce components of the media.

FIG. 9 illustrates one embodiment of gathering user information on content associated with the media project.

FIG. 10 illustrates one embodiment of a web page used to view costs associated with different combinations of aspects.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for managing the conception and creation of media. The system allows media project managers to create media projects by uploading concepts for media projects including, but not limited to, video projects, audio projects, web projects and any other media based project. Media can include anything that can be viewed and edited on a computer, including, but not limited to text documents, graphical images, movies, audio files, flow chart documents, three dimensional renderings, scanned images or any other file which may be opened and edited on a computer. Once a project is created, other users can manipulate the media posted and provide comments and feedback as to the direction and content of the media. The system also allows investors, advertisers and others to obtain information concerning the media project for investment purposes. In addition, the system gathers information concerning users providing comments concerning media projects in order to ascertain the interest of different demographic groups in the media project. The system may also include a virtual store which allows media project managers to sell their media products to investors, solicit bids for services required to produce the media and to solicit artists to work on different media projects.

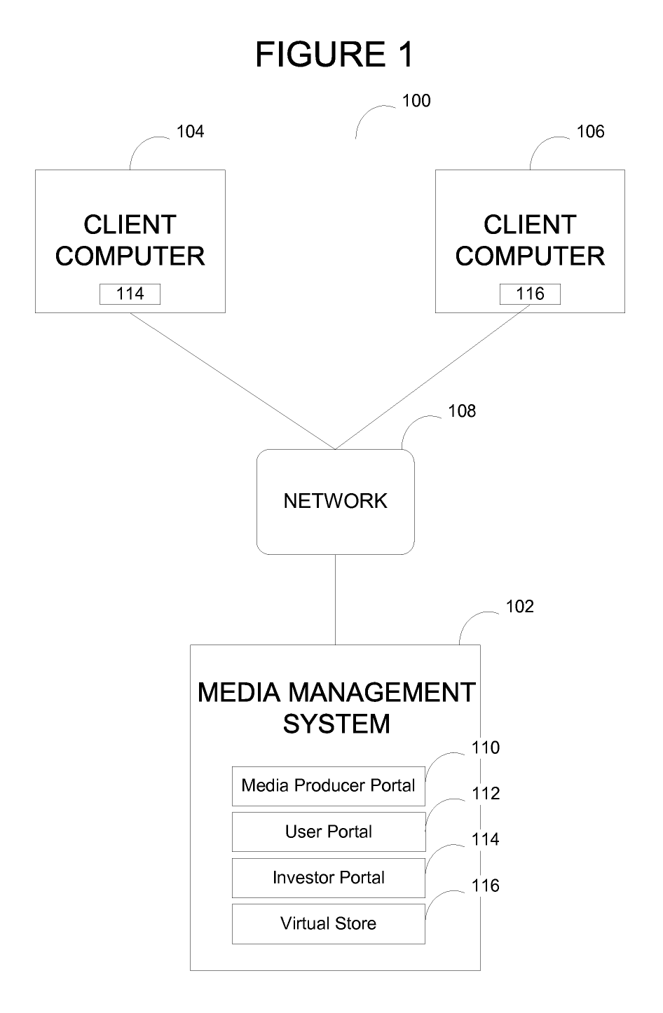

FIG. 1 depicts a block diagram of a media management system 100 suitable for use with the methods and systems consistent with the present invention. The media management system 100 comprises a plurality of computers 102, 104 and 106 connected via a network 108. The network is of a type that is suitable for connecting the computers for communication, such as a circuit-switched network or a packet-switched network. Also, the network may include a number of different networks, such as a local area network, a wide area network such as the Internet, telephone networks including telephone networks with dedicated communication links, connection-less network, and wireless networks. In the illustrative example shown in FIG. 1, the network is the Internet. Each of the computers shown in FIG. 1 is connected to the network via a suitable communication link, such as a dedicated communication line or a wireless communication link.

In an illustrative example, computer 102 serves as a media management unit that includes a media project manager portal 110, a user portal 112, an investor portal 114 and a virtual store 116. The number of computers and the network configuration shown in FIG. 1 are merely an illustrative example. One having skill in the art will appreciate that the data processing system may include a different number of computers and networks. For example, computer 102 may include media project manager portal 110 as well as one or more of the user portal 112. Further, the investor portal 114 and virtual store 116 may reside on a different computer than computer 102.

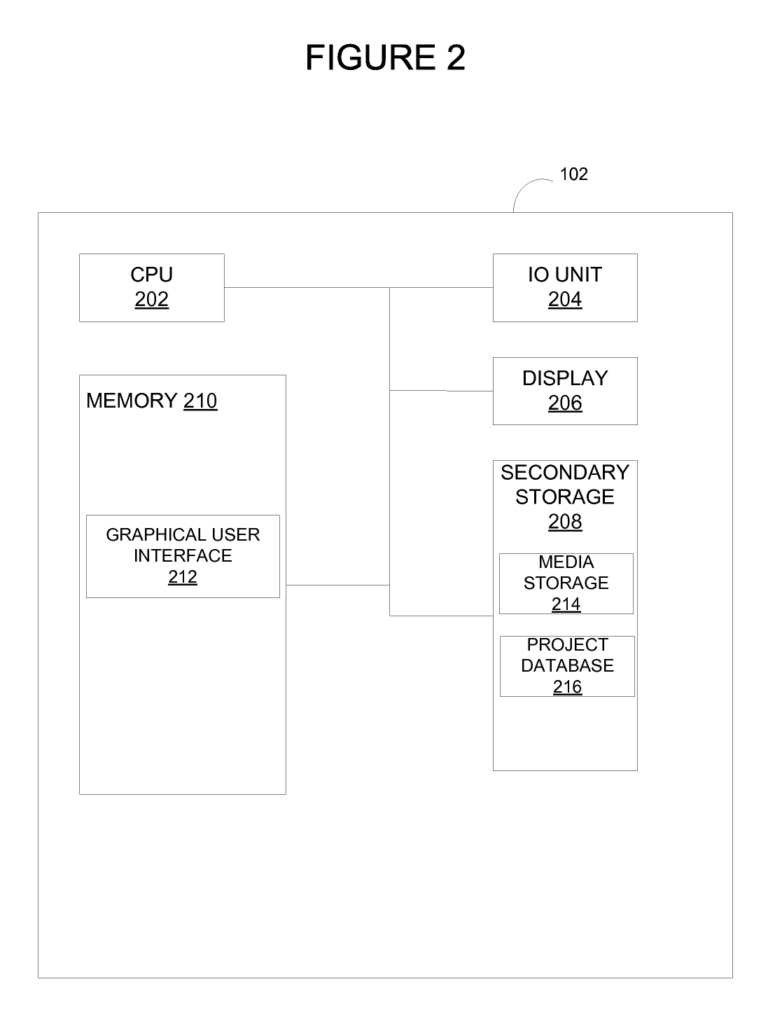

FIG. 2 shows a more detailed depiction of computer 102. Computer 102 comprises a central processing unit (CPU) 202, an input output (I/O) unit 204, a display device 206, a secondary storage device 208, and a memory 210. Computer 102 may further comprise standard input devices such as a keyboard, a mouse, a digitizer, or a speech processing means (each not illustrated).

Computer 102′s memory 210 includes a Graphical User Interface (“GUI”) 212 which is used to gather information from a user via the display device 206 and I/O unit 204 as described herein. The GUI includes any user interface capable of being displayed on a display device 206 including, but not limited to, a web page, a display panel in an executable program, or any other interface capable of being displayed on a computer screen. The secondary storage device 208 includes media storage unit 214 which stores computer readable versions of the media and a project database 216 which stores information on each media project. Further, the GUI 212 may also be stored in the secondary storage unit 208. In one embodiment consistent with the present invention, the GUI is displayed using commercially available hypertext markup language (“HTML”) viewing software such as, nut not limited to, Microsoft Internet Explorer, Google Chrome or any other commercially available HTML viewing software.

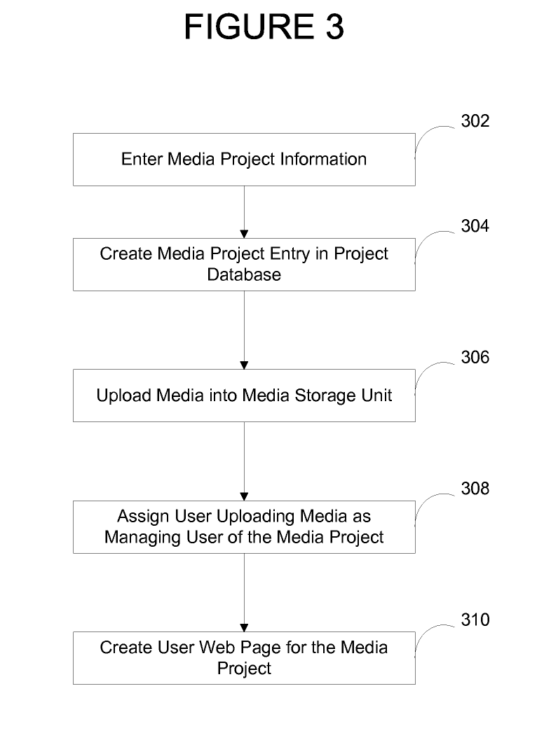

FIG. 3 depicts a flow diagram 300 illustrating exemplary steps by the media management system 100 for creating a media project. First, in step 302, a media project manager enters information concerning a media project into a project database 216 on the secondary storage unit 208 via the GUI 212. Information entered into the project database 216 can include, but is not limited to the project name, media developer's names, project development stage, investor's names, contact mailing, address, contact e-mail address or any other information which pertains to the media being uploaded. The project database 216 may be any commercially available database software including, but not limited to SQL, mySQL, Oracle, or any other relational or multidimensional database.

In step 304, the media management system 100 creates entries in the project database 216 on the secondary storage unit 208 with the information pertaining to the media project. At the same time, the media management system 100 allocates memory in the media storage unit 214 for any files associated with the media project. The media storage unit 214 allocates a predetermined amount of memory in the media storage unit 214 for each project when the media project is created in the project database 216. The location of the memory in the media storage unit holding the media files is stored in the project database 216 and is associated with the media project. Hereinafter, “associate” and “association” is defined as relating pieces information stored in a database.

In one embodiment consistent with the present invention, the media management system 100 may interact with commercially available operating system software operating on the computer, or computers, operating the media management system 100, such as Microsoft Windows®, Linux® or any other available commercially available operating software, to allocate memory for the media project files. When commercially available operating software is used for memory allocation, the media management system 100 interacts with an application programming interface (“API”) to allocate memory locations in the media storage unit 214 to store the media files.

In step 306, the media project manager uploads the media files into the media storage unit 214. The media can be in any format including, but not limited to, JPEG, MPEG, MP3, Audio Video Interface (AVI) formats or any other media format capable of being read by a computer. The media files may be uploaded to the media storage unit 214 from a computer 102 using any commercially available web server software, including, but not limited to Microsoft Internet Information Server, Apache Web Server, Savant Web Server or any other commercially available web server. The media management system 100 provides the web server software with memory locations in the media storage unit 214 to store the media files. The web server software then writes the media files to the memory locations in the media storage unit 214. In one embodiment consistent with the present invention, the media storage unit 214 dynamically allocates additional memory in the media storage unit 214 for a media project when a media project requires more memory to store media files and stores the additional memory locations in the project database 216. In another embodiment consistent with the present invention, the media storage unit 214 may store media files across multiple memory locations each residing on a different computer connected to the network 108.

In one embodiment consistent with the present invention, the media project manager uploads the media via the GUI 212. In another embodiment consistent with the present invention, the media is sent via a structured e-mail message to the media storage unit 214. In this embodiment, an application running in the memory of the media management system 100 interacts with commercially available e-mail software including, but not limited to, Microsoft Exchange Server or any other commercially available e-mail software using an API. The application opens each e-mail and extracts any files and information identifying the media files from the e-mail. The media management system 100 then queries the project database 216 to locate the memory locations on the media storage unit 214 where media files associated with the media project are stored. The media management system 100 then stores the files in the appropriate memory location of the media storage unit using one of the methods described above.

In another embodiment consistent with the present invention, the media project includes text documents. The text documents can include specific information pertaining to the media project such as, but not limited to, acting scripts, budget estimates of production, screen description, shooting schedules or any other information relating to the media project. In one embodiment consistent with the present invention, the media project manager uploads the text document via the GUI 212 using any of the methods previously discussed for uploading media files. In another embodiment consistent with the present invention, the text document is sent via an e-mail message to the media storage unit 214 and is extracted from the e-mail in the same manner described above for extracting media files from e-mail messages. The text documents are uploaded and stored in the media storage unit 214 using any of the methods described above.

In yet another embodiment, the media project manager can associate the text document with specific media. As an illustrative example, a media project manager can upload a media file of a short film to the media storage unit 214 followed by the script used in the short film. The media management system 100 allows the user, via the GUI, to associate the script of the short film with the media project. To accomplish this association, the media management system 100 creates an entry in the project database 216 that relates a media file with a specific text file and vice versa. In another embodiment consistent with the present invention, the media management system allows a user to associate more than one media file with a text document or more than one text document with a media file.

In Step 308, the media management system 100 designates the user uploading the media to the media storage unit 214 as the media project manager. In one embodiment consistent with the present invention, the media management system adds the user uploading media files or text documents to the project database 216 and associates the user with the media project. In another embodiment consistent with the present invention, the media project manager is granted rights to add, delete and modify any text documents or media associated with the media project by modifying the user entry in the project database 216. In addition, the media project manager is granted rights to prevent or allow other users from viewing any text documents or media associated with the media project. In one embodiment consistent with the present invention, user access management may be provided by commercially available user access software including, but not limited to, Web Access Management®, Microsoft Internet Information Server ®, Apache® or any other software capable of managing user access to a web page.

In Step 310, the media management system 100 creates a user web page 400 in the user portal which allows a user of the system 100 to view and modify the uploaded media and text documents. The media management system 100 creates new user web pages using HTML templates stored in the memory of the media management system 100. Software running on the media management system 100 creates a new HTML file in a web server using the HTML templates stored in the memory of the media management system and populates fields in the HTML template with information concerning the media project from the project database 216. The media management system 100 then saves the HTML file in the web server software and associates the new HTML file with the media project in the project database 216. In another embodiment consistent with the present invention, the media management system 100 may use commercially available web site management software, including but not limited to Adobe Dream weaver, Microsoft Front Page or any other commercially available web page management software to manage the automatic creation of web pages.

In one embodiment consistent with the present invention, the user web page 400 allows other users to view the uploaded media along with the uploaded text document using any of the methods previously mentioned. In step 308, the media management unit creates a media project manager management page, using any of the methods for web page creation previously described, which allows the media project manager to manage the uploaded media and text. In one embodiment consistent with the present invention, the media project manager web page allows a media project manager to create additional dependant web pages where additional media and text files can be uploaded.

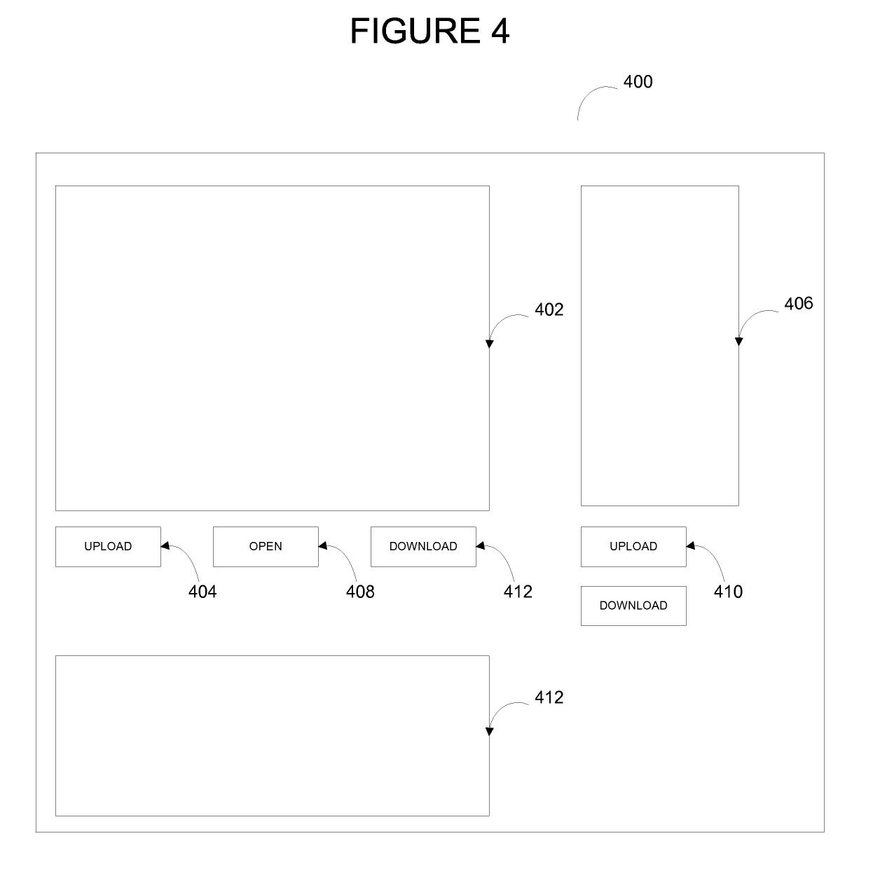

FIG. 4 depicts one embodiment of a user web page 400 that is consistent with the present invention. The user web page 400 includes a media display unit 402 which allows users to view media uploaded into the media storage unit 214. The media display unit 402 also includes an upload button 404 which allows users to upload media to the media storage unit 214. In one embodiment consistent with the present invention, the upload button 404 displays a list of all media on the client computer 102 using a standard HTML upload form that is known in the art which allows the user to select the media to upload to the media storage unit 214. Once the media is selected, the media is transmitted from the client computer 102 to the media storage unit 214 via the network 108 using any of the commercially available web server software programs previously described. The media management system 100 then stores the media file in the memory locations allocated for the media project using any of the methods discussed herein. The user web page 400 is developed using any of the methods described previously and is displayed via the GUI 212 using any commercially available web server software as previously described.

The media storage unit 214 stores the uploaded media and also creates an entry in the project database 216 on the secondary storage unit 208 which associates the uploaded media with a media project. In one embodiment consistent with the present invention, the media storage unit 214 also stores additional information concerning the client computer 102 and the media in the project database 216. The additional information may include, but is not limited to, the Internet address of the client computer 102, the name of the user uploading the data, the date and time the file was uploaded and any other information which is suitable to identify the client computer or the media which is uploaded. In one embodiment consistent with the present invention, the information on the client computer is obtained via the web server serving the web page. In another embodiment consistent with the present invention, the web page served by the web server software includes executable software code that queries the client computer 104 for information and transfers the information to the project database 216.

Once the media is loaded into the media storage unit 214, the user can view the media using the media display unit 402. The media display unit 402 may be any commercially available media viewer, such as QuickTime, Microsoft Media Player, iTunes or any other software of playing or displaying a standard media file, such as a JPEG, AVI, MP3, MPEG or any other standard media formatted file. The user web page 400 also includes an open button 408 which allows a user to view other media associated with the media project that is stored in the media storage unit 214. In one embodiment consistent with the present invention, the open button executes HTML code which interacts with the web server software previously mentioned to provide the location of the media files in the media storage unit 214 to the media viewing software. In another embodiment consistent with the present invention, the media management system provides the memory location in the media storage unit 214 of the selected media to the media viewing software.

The user web page 400 also includes a media download button 412 that allows users to download any media which is associated with the media project to the client computer 102. In one embodiment consistent with the present invention, the media management system 100 stores information on the media download in the project database 216. In one embodiment consistent with the present invention, the information is gathered as part of the user registration process and is stored in the project database 216. The information may include, but is not limited to, the date and time the media is downloaded, the user's name, e-mail address, home address, user account number or any other information which can be used to identify the user downloading the media. In another embodiment consistent with the present invention, the media contains an identifier which identifies the entity who created the media as well as the entities which have provided edits to the media. Once the user selects the media, the media is transferred to a local storage unit on the client computer 104 via the network 108 by the web server software using any of the methods previously discussed.

Once on the client computer 104, the user may edit the media using commercially available editing software such as Photoshop, QuickTime, MAGIX or any other commercially available media editing software. Once the editing is completed, the user may upload the edited video into the media storage unit 214 by selecting the media upload button 404 using any of the methods previously discussed for uploading media. When the user selects the media upload button 414, the user portal 112 enters information on the edited media being uploaded to the project database 216 including, but not limited to, the date and time of the upload, an identifier for the media, the name of the user uploading the data or any other information which can identify the media in the media storage unit 214. In addition, the user portal 112 associates the edited media with the media project in the project database 216.

The user web page 400 also includes a text document upload button 410 which allows a user to upload a text document and associate the text document with a media project using any of the methods previously discussed. In one embodiment consistent with present invention, the media management system 100 stores the text document in the media storage unit 214 and also creates an entry in the project database 216 which associates the uploaded text document with the media project. In another embodiment consistent with the present invention, the media management system 100 also associates the text document with one or more specific media files in the media storage unit 214. In another embodiment consistent with the present invention, the media management system 100 also stores additional information concerning the client computer 102 and the text document in the project database 216 using methods similar to information discussed prior. The additional information may include, but is not limited to, the Internet address of the client computer 102, the name of the user uploading the data, the date and time the file was uploaded and any other information which is suitable to identify the client computer 102 or the media which is uploaded.

The user web page 400 also includes a text viewer unit 406 which allows a user to view all text documents associated with the media project. In one embodiment consistent with the present invention, the user can select a text document from the test view unit 406 which then displays the selected text document in the text display unit 412. In another embodiment, the user web page 400 will display the video associated with the text document in the media display unit 402. The text viewer may be any commercially available text viewing software including, but not limited to, Microsoft Office, Open Office or any other commercially available text viewing software.

The user media display area 404 includes a text document download button 416 which displays a list of all documents provided by the user which are associated with the media project which a user can select to save on a client computer 104 using any of the previously described methods. In one embodiment consistent with the present invention, the media management system 100 stores information on the downloaded text document in the project database 216. The information may include, but is not limited to, the date and time the text document is downloaded, the user's name, e-mail address, home address, user account number or any other information which can be used to identify the user downloading the text document. In another embodiment consistent with the present invention, the text document contains an identifier which identifies the user as the entity creating the text document. Once the user selects the text document, the text document is transferred to a local storage unit on the client computer 104 via the network 108.

Once the text document is transferred to the client computer 104, the user may edit the text document using commercially available editing software such as Microsoft Notepad, Open Office or any other text document editor. Once the editing is completed, the user may upload the edited text document into the media storage unit 214 by selecting the text document upload button 416 which allows a user to select a text document to upload to the media storage unit 214 using any of the methods previously discussed. When the user selects the text document upload button 416, the user web page 402 enters information on the edited text document being uploaded to the media storage unit 214 including, but not limited to, the date and time of the upload, an identifier for the text document, the name of the user uploading the text document or any other information which can identify the media in the media storage unit 214. In addition, the user web page 402 associates the edited text document with the media project in project database 216 on the secondary storage unit 208 using any of the methods previously discussed.

Once the edited document is in the media storage unit 214, it becomes associated with the media project in the project database 216. Accordingly, the edited text documents and edited media are displayed in the list of media associated with the media project and can be viewed and edited by other users. The media project manager can monitor the edited video and text documents uploaded and also delete edited video and text documents from the media project using the previously described user web page. In another embodiment consistent with the present invention, the media project manager can associate one media file with more than one media projects in the project database 216 using the user web page. The user web page may be configured to allow a user to select a media entry and to copy the media entry to another project.

In one embodiment consistent with the present invention, the media management system 100 includes a user registration unit which gathers information on users of the information management system 100 via the GUI and stores the user information in a registration unit in the project database 216. Consistent with this embodiment, users enter information via the GUI 212 and then click a “submit” button. When the user clicks the “submit” button HTML code associated with the “submit” button initiates a database command, such as a structured query language (“SQL”) command, which inserts the information into the project database 216. In another embodiment consistent with the present invention, the user registration unit is any commercially available user registration software including, but not limited to, OAMP Web User Module®, Microsoft Internet Information Service®, Apache Web Sever®, JavaScript® or any other commercially available user registration software.

The media management system 100 gathers information including, but not limited to, the first and last name, e-mail address, home address, work address and profession of the user via the user registration unit. Each user is also assigned a username and a password which allows the user to access the media management system 100. In another embodiment consistent with the present invention, the registration unit incorporates an authentication unit which authenticates a user based on a unique identifier, such as the machine access code of the user's client computer, one of the IP addresses associated with the user, or any other unique information which can be used to identify the user. In another embodiment consistent with the present invention, the authentication software is any commercially available authentication software, including, but not limited to Microsoft Internet Information Server®, Apache Web Server® or any other authentication software.

In another embodiment consistent with the present invention, the user web page 400 may include a mapping window displaying the current location of the media producer or the party shooting live video. In addition, the live video may be displayed in the media display unit using any commercially available video streaming software such as Quicktime®, Broadcam Live or any other commercially available video streaming software. In addition, the media management system may incorporate a telecommunication software system such as Webex®, Adobe®, Skype® or any other commercially available internet telecommunication software to allow users to communicate with the party creating the media in real time.

In another embodiment consistent with the present invention, the media project manager may enter in the Global Positioning Coordinates (“GPS”) of the location where media is being produced or was produced. The GPS location is then stored in the project database and is associated with the media project. The media project manager can also associate any of the media in the media storage unit 214 with specific GPS coordinates by entering the CPS coordinates into the project database.

In another embodiment consistent with the present invention, the GPS coordinates are loaded into the web page by a GPS communication unit using any commercially available GPS device and related software such as Garman GPS. In another embodiment consistent with the present invention, the GPS coordinates may be entered using a web page, e-mail or SMS message using any of the previously described methods. In addition, the project database may associate the GPS coordinates to a named location created by the user and entered into the project database. In another embodiment consistent with the present invention, the media management system 100 may graphically show the location where the media was, or is being, produced using any commercially available mapping software such as GoogleMaps®, Mapquest® or any other commercially available mapping software. In addition, the media management system 100 allows users to search for media based on the GPS coordinates, or associated location, where the media was produced.

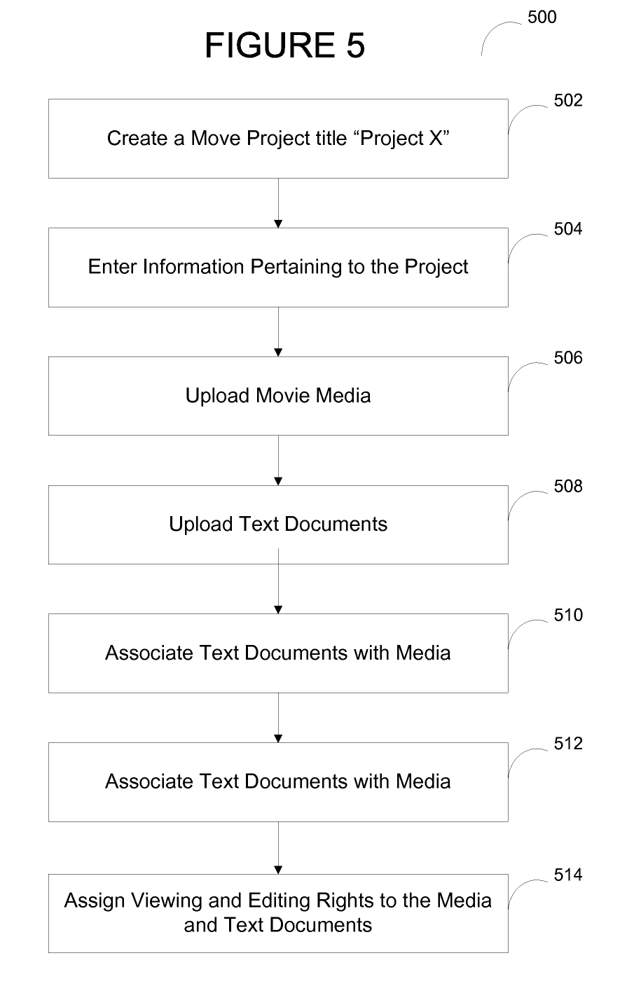

FIG. 5 illustrates a method of managing a media project consistent with the present invention. In step 502, a movie producer opens a home page of the move management system 100 and creates a new movie project titled “Project X.” In step 504, the movie producer enters information into the project database 216 via a web page hosted by the media management system 100. The information entered includes the number of scenes for the movie, the estimated budget for the movie, the names of the characters in the script and film, the genre of the move and a general description of the setting, plot and characters in the movie.

In step 506, the movie producer uploads media pertaining to the movie using any of the methods previously discussed. As an illustrative example, the movie producer may upload a scene from the movie taped in a digital format. In addition, the movie producer may upload story boards depicting each scene in the movie, as well as, artist renderings of the costumes and artwork related to the movie.

In step 508, the movie producer uploads text documents associated with the movie using any of the methods previously discussed. As an illustrative example, the movie producer may upload the script for the movie. In step 510, the movie producer may associate the text document with one or more of the media uploaded in step 506. In step 512, the movie producer assigns editing and view rights for each media and text document to one or more users. The editing and viewing rights grant or restrict one or more users from downloading, editing or viewing the media and text documents. The user rights are attributes associated with the user and stored in the project database 216. In another embodiment consistent with the present invention, the user access is restricted by the web server software previously discussed. In another embodiment consistent with the present invention, the media management system 100 allows all users to view and edit the media and text documents associated with the media project.

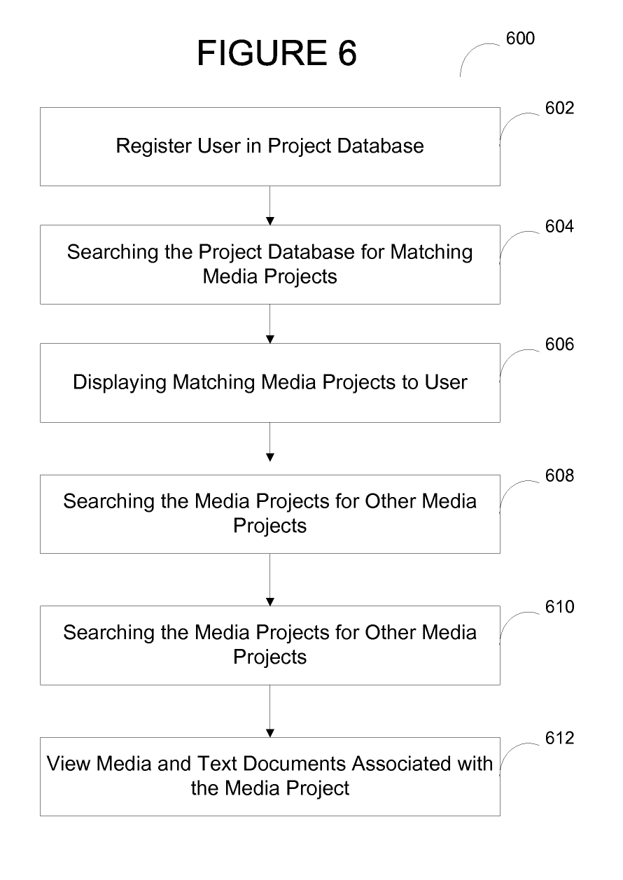

FIG. 6 illustrates a method of managing investments in a media project consistent with the present invention. In step 602, a user registers with the media management system 100 via the user portal as previously discussed. In the registration process, the user enters information pertaining to the user including, but not limited to, the user's name, home address, e-mail address, favorite movie genres, favorite music and any other information pertaining to the user. The media management system 100 stores the information pertaining to the user in the project database 216. In step 604, the media management system 100 searches the project database 216 on the secondary storage unit 208 for media projects that fit the interests of the user based on the information provided by the user during the registration process. This search functionality is provided by executable code in the media management system 100 that generates an SQL query which searches the project database 216 for media projects include categories similar to the user's interests stored in the project database 216. In step 606, the media projects identified as matching the user's interests are displayed to the user via the GUI 212.

In step 608, the user is allowed to search the project database 216 in the project database 216 manually for other projects using a search function on a user search web page. The search function requests keywords from the user and then structures a database query which searches the project database 216 for media projects that match the keywords entered in the user web page. The user may also search the project database 216 based on the genre associated with a media project, the title of the media project, the media project manager of the media project or any other information associated with the media project by selecting a drop down box on the user search web page. One the user selects the drop down box, the user search web page executes program code which structures a database query to return all media projects associated with the selected genre, title or media project manager. Further, when the user opens the user search web page, the user search web page fills the drop down boxes with all the genres, titles and media project managers currently in the database by structuring a query to gather and return all of the types of genres currently associated with media projects in the media database.

In step 610, the user selects one of the media projects listed on the web page by the media management system 100 via the GUI 212. If the selected project is protected by the media project manager, a message is sent to the media provider requesting access for the user. Upon receiving the notification, the media project manager may allow the user to view the media project and/or edit the content associated with the media project or may deny the user access to the media project. The media project manager may grant access by instructing the web server software to allow the user to access the web page. In step 612, the user is directed to the user web page 400 where the user is able to view, download and upload media and text documents. As stated earlier, the user can edit media and text documents associated with the media project and upload these edits back into the media storage unit 214. In one embodiment consistent with the present invention, the media management system associates an identifier for the user viewing the media project with the media project in the project database 216 as previously disclosed.

In another embodiment consistent with the present invention, the media management system 100 creates an investment web page which allows users designated as investors by the media project managers (herein referred to as “investors”) to view detailed information on each media projects. The investment web page is created using any of the methods previously described. Continuing with the example of the movie producer described above, the detailed information can include, but is not limited to, information on each user viewing the media project, information on each user downloading and uploading media from each media project, the estimated cost of the project, information on the characters and actors contracted to play the characters in the movie. In one embodiment consistent with the present invention, the media management system 100 allows investors to track each project to determine the level of interest in users of different socioeconomic backgrounds.

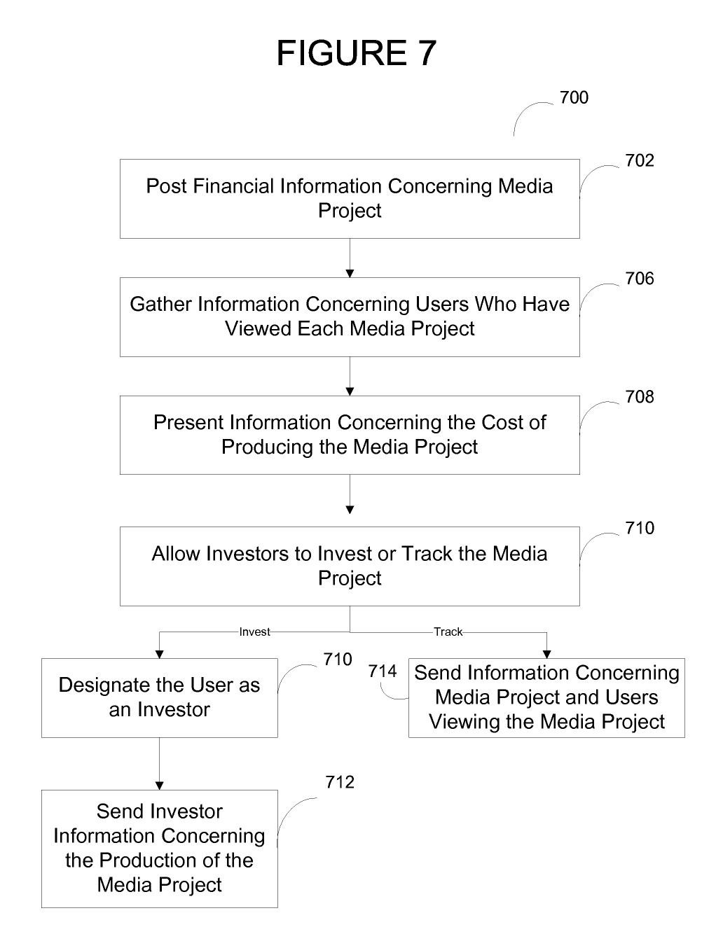

FIG. 7 illustrates one embodiment of a method of soliciting and tracking an investment in a media project consistent with the present invention. In step 702, the media project manager inserts the estimated investment costs of the media project into the project database 216 using a web page which allows the media project manager to input information on the costs of the media project directly into the project database 216. In addition, the media management system 100 inserts information on each user accessing a media project by storing each user's activity in the project database 216.

In step 704, the media management system 100 gathers the information concerning all users who have viewed downloaded or edited media and text documents for the media project from the project database 216 and presents the information to one or more investors via a web page generated using any of the methods for web generation previously discussed. In another embodiment consistent with the present invention, the media management system 100 allows the investor to define the information that the media management system 100 should gather concerning the media project. In this embodiment, investor enters keyword indicating the information to gather from the project database 216. Executable programming code then structures and executes a database query which retrieves the information from the database and sends the information back to the web page. The web page receives the information and displays the information in a plurality of fields on the web page. In step 706, the media management system 100 presents information pertaining to the estimate cost to produce the media project including, but not limited to, cost of production, travel, costume design or any other cost associated with the media production.

In step 708, the media management system 100 allows the investor to commit to an investment in the media production or to track information on the media project. In one embodiment consistent with the present invention, the media management system 100 allows the investor to make an investment offer to the media project manager by sending an e-mail message to the media project manager via the media management system using any commercial e-mail software including, but not limited to, Microsoft Exchange. The media project manager can then accept or decline the offer by a return e-mail which is stored in the media storage unit 214 and is associated with the media project in the project database 216. In step 710, if the media project manager accepts the investment offer, the media management system 100 associates the investor with the media project by associating the user as an investor in the media project in the media database.

In step 712, the media management system 100 automatically sends the investor information concerning the production of the media project including, but not limited to, costs of production, edits and changes to the media by the media project manager, new posts of media such as dailies to the investor. The media management system 100 may utilize any commercial reporting software such as Intelliview, Crystal Reports or any other software capable of creating reports from information stored in a database. In another embodiment, the media management system 100 requires authorization from the investor and the media project manager before changes are made to the media. In this embodiment, the investor and user must authorize the granting of access rights to new users. In yet another embodiment consistent with the present invention, the investor is granted the right to exclude specific users from viewing, downloading or editing the media associated with the project using any of the user authentication methods previously discussed. In another embodiment consistent with the present invention, the media management system 100 allows the investor to exclude all users from viewing the media project using the authentication methods previously discussed.

In step 714, if the investor tracks the media project, the media management system 100 sends information pertaining to the popularity of the media project, such as, but not limited to, the number of users viewing the media project, demographic information concerning the users viewing the media project, revised production cost estimates and any other information relating to the investment potential of the media project. The media management system 100 regularly queries the project database 216 for the information requested by the investor and presents the information on a web page or in a report generated using any of the previously discussed web page and reporting methods.

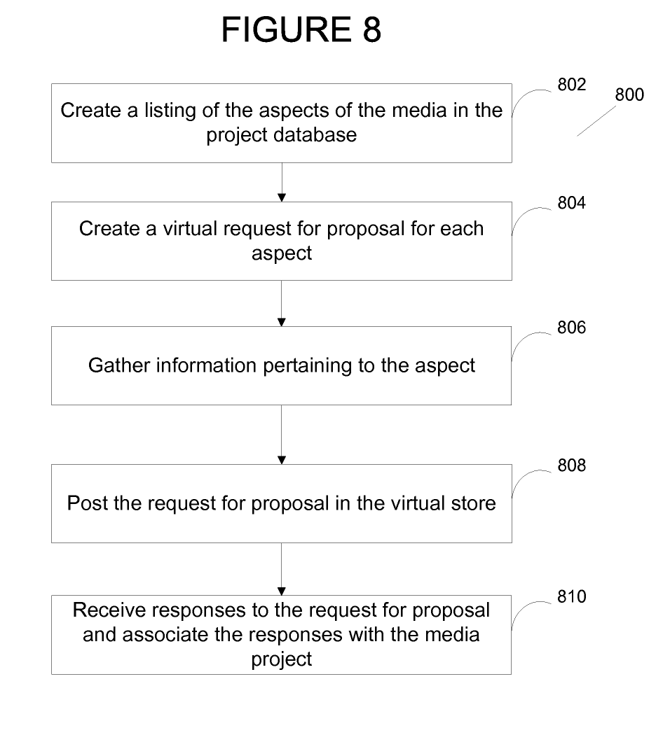

FIG. 8 illustrates one embodiment of a method of soliciting proposals to produce components of the media. In step 802, the media management system 100 generates a list of aspects associated with a media project. In one embodiment consistent with the present invention, the list of aspects is based on a classification of the media project provided by the media project manager that is stored in the project database 216 and associated with the media project. Media classification categories can include, but are limited to movie, music, advertisement, fashion design or any other indicator that would classify the media. In another embodiment consistent with the present invention, each classification can have one or more sub classifications. The sub-classifications can include, but are not limited to, genre, artistic style, media type, or any other indicator which would further classify the media.

In one embodiment consistent with the present invention, the media management system 100 creates an aspect list in the project database 216 based on predefined aspect lists for each classification or sub-classification. In another embodiment consistent with the invention, the media management system 100 parses the content of the media project to determine a classification and sub-classification for the media project. Consistent with this embodiment, the media management system 100 identifies key terms in the content associated with the media project, and the number of occurrences of the key terms in the content, to determine the classification of the media project. The media management system 100 can use any commercially available object character recognition (“OCR”) software to recognize the key words in the content such as, but not limited to, Adobe Acrobat or any other commercially available OCR software.

As an illustrative example, the media management system 100 identifies a document titled “script” associated with a media project and parses through the script document associated with a media project to identify key words or phrases in the document that would identify the classification of the media. In the script document, the media management system 100 identifies the word “mafia” in numerous portions of the script. Based on these keywords, the media management system 100 classifies the media as a movie and also as a mafia movie and associates the classification in the project database 216. Based on the classification, the media management system 100 develops a list of aspects of a movie from a list of aspects stored in the media storage unit 214 or a list of aspects associated with a mafia movie stored in the project database 216. In another embodiment consistent with the present invention, the media management system 100 allows the media project manager or an investor to assign a category and a subcategory based on a list of potential categories and subcategories indicated by the media management system 100 in the project database 216.

In step 804, the media management system 100 creates a request for proposal for each aspect of the media project in the project database 216. In one embodiment consistent with the present invention, the request for proposal is based on previously generated requests for proposals for similarly classified media projects. In another embodiment consistent with the present invention, the media management system 100 solicits information on the aspects of the media project and the content of the request for proposals from the media project manager or investors. In another embodiment consistent with the present invention, the requests for proposals are assigned to an aspect of the media project from the list of previously assigned aspects. In step 806, the media management system 100 identifies information in the media project associated with the request for proposal. In one embodiment consistent with the present invention, the media project manager or investors associate information in the media project with each request for proposal.

In step 808, the media management system 100 associates the request for proposal with an entry in a virtual store. In one embodiment consistent with the present invention, the entry includes links to the media project as well as the aspect associated with the request for proposal. In another embodiment consistent with the present invention, a request for proposal is associated with multiple aspects. In step 810, the media management system 100 receives responses to the requests for proposals and associates these requests with the media project via the virtual store and associates the responses with the media project. The virtual store is a collection of web pages that display information on requests for proposals. The web pages are developed using any of the web page development methods previously discussed.

As another illustrative example, a movie is created in the media management system 100 that includes a script and other information concerning the scenes and potential locations for to shoot different scenes for the movie. The media project manager or an investor identifies the characters in the movie and enters the different names of the characters into the media management system 100. The media management system 100 creates a separate aspect for each character the in the project database 216 of the media management system 100 and associates each individual character aspect with the previously entered character aspect in the project database 216. In addition, the media management system 100 allows the media project manager or investor to associate content associated with the media project with each aspect. In this example, the script would be associated with each character, as well as any documents describing the character or the requirements of the actor playing the character. Further, the media management system 100 creates a separate web page for each request for proposal and associates the request for proposal web page with the media project using any of the previously mentioned methods.

Once the aspects are created and the content is associated with each aspect, the media management system 100 creates an entry on a virtual store web site that allows users to search for specific types of requests for proposals. In this example, actors or casting agents can search for movie roles and respond by providing video of an actor acting out the script. The actor or casting agent can upload the video through the virtual store which is then stored in the media storage unit 214 using any of the previously mentioned methods. Once the video is uploaded, it is associated with the media project and can be viewed by the investors and the media project manager.

In another illustrative example, the media project manager or investor can describe different locations for shooting scenes in the move as an aspect of the media project. The media management system 100 creates an aspect in the project database 216 for the different scene location descriptions. The media project manager or investors then assign different content associated with each scene location with the script of the movie. The media management system 100 then posts the request for proposals for each scene location in the virtual store. Different municipalities can then respond to the request for proposal for each location with detailed descriptions of their proposed locations as well as the incentives for the investors or media project manager to select their location. Each proposal is then associated with the corresponding aspect in the project database 216.

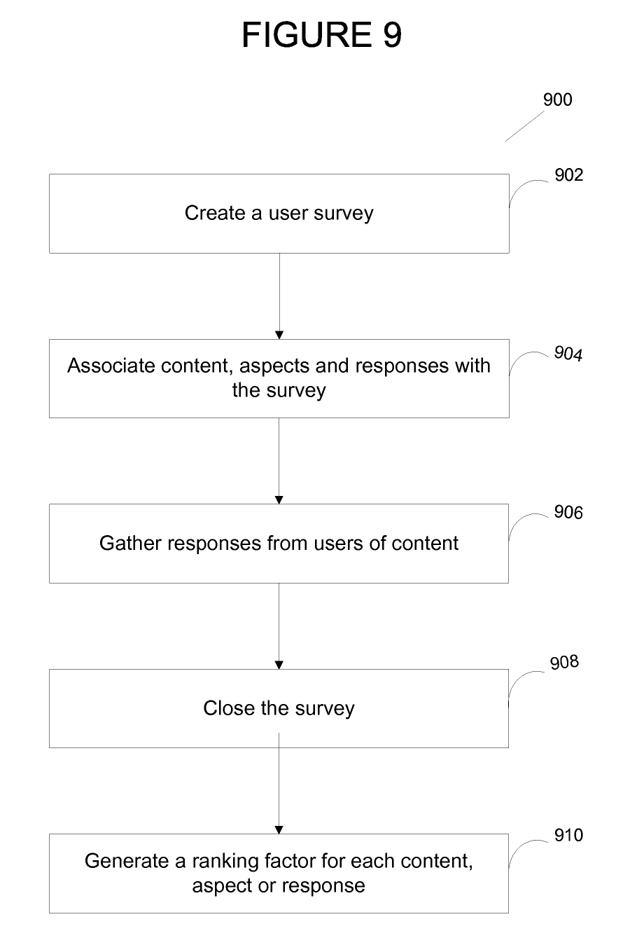

FIG. 9 illustrates one embodiment of gathering user information on content associated with the media project. In step 902, a user survey entry is created in the project database 216 and is assigned with the media project. In one embodiment consistent with the present invention, a survey includes questions which indicate a user's interest in the content associated with the survey. In another embodiment consistent with the present invention, a survey includes a ranking system for the content associated with the survey which indicates a user's interest or approval of the content. In yet another embodiment, the survey is a combination of questions and a ranking system. The survey is developed using any commercially available survey software including, but nor limited to, SurveyGizmo, IBM SPSS, or any other commercially available survey software.

In step 904, the media project manager or investor associates content, aspects and responses from the media project with the survey. In step 906, the media management system 100 gathers responses to the content from users by a survey web page which is associated with the media project. In one embodiment consistent with the present invention, the media management system 100 creates a tab in the user web page 400 which lists all active surveys for the media project and allows users to open and complete various surveys. In another embodiment consistent with the present invention, the survey may be restricted to specific users based on characteristics of the user, including, but not limited to age, sex, occupation or any other characteristic of a user. In another embodiment consistent with the present invention, the content of the survey may change based on the characteristics of the user.

In step 908, the survey is closed and the results of the survey are stored in the project database 216. Closing the survey prevents users from responding to the survey questions or rankings. In step 910, the media management system 100 analyzes the results of each survey to determine an overall indicator of user interest in the content associated with the survey. In one embodiment consistent with the present invention, the media management system 100 averages the rankings included in the survey to determine the average ranking of each piece of content associated with the survey. In another embodiment consistent with the present invention, the media management system 100 generates separate indicators based on the characteristics of the users responding to the survey.

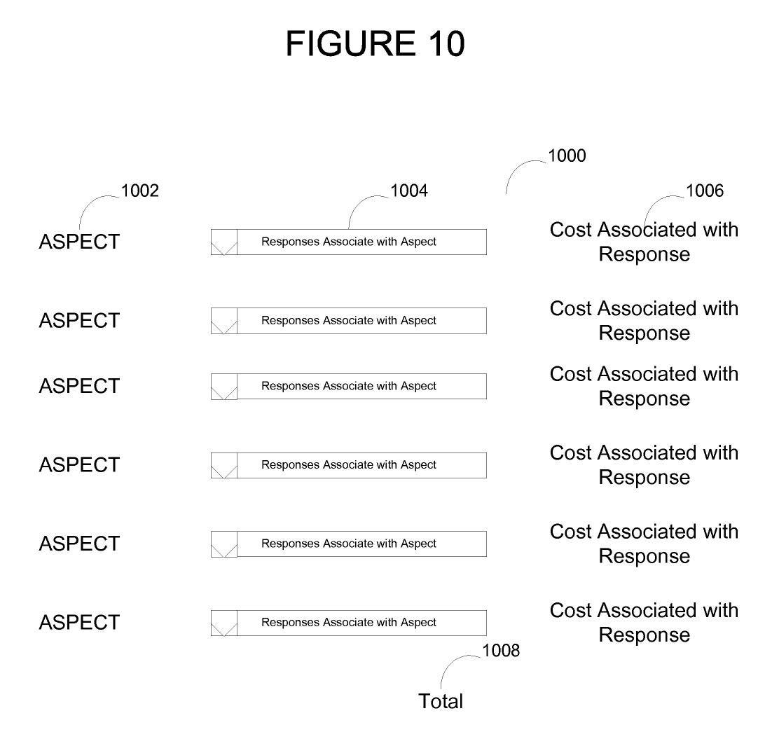

FIG. 10 illustrates one embodiment of a web page used to view costs associated with different combinations of aspects. The web page includes a listing of each aspect 1002 which has received a response to a request for proposal in the project database 216. The web page also includes a listing of descriptors 1004 of all of the responses associated with the response as well as the cost associated with the response 1006. In one embodiment consistent with the present invention, the listing of descriptors 1004 allows the user to select from a list of all the responses associated with the aspect in the project database 216. When a user selects a descriptor from the listing of descriptors 1004, the cost associated with the response 1006 changes to show the cost associated with the descriptor. The web page is developed using any of the web development methods previously discussed.

The web page also includes a totalization field 1008 which adds each of the costs 1006 to determine the total cost of using different aspect combinations. In another embodiment consistent with the present invention, the media management system 100 also displays any rankings associated with the aspect. In yet another embodiment, the media management system 100 generates an estimate of the cost of producing the media project by adding the costs associated with the highest ranking aspects. In another embodiment, the media management system 100 generates a cost estimate based on the lowest ranking aspects.

An illustrative example of one embodiment consistent with the present invention, a fashion designer may upload images of a new clothing design. The media management system 100 creates a new media project in the project database 216 and designates the designer as the media project manager. The media project manager then uploads digital images of the fashion design which are stored in the media storage unit 214. In addition, the media project manager uploads documents describing the materials used to make the new fashion design.

Users of the media management system 100 who located the new fashion design by searching for fashion designs in the project database can then download the images and documents, modify the images and documents and upload the new files to the media storage unit where other users and the media project manager can view the proposed changes. In addition, the media management system 100 gathers data on the users viewing the fashion design project and the media project manager can use the information gathered on the users to solicit investors for the fashion design project.

Potential investors can “tag” the fashion project to view the proposed changes to the fashion design suggested by the users and any modifications to the design posted by the media project manager. In addition, the media project manager can send potential investors information pertaining to the characteristics of the users viewing the fashion design. If a user invests in the project, the media project manager can designate the user as an investor and can grant additional rights to the user.

If the media project manager or investor decide to solicit proposals to manufacture the fashion design, the media project manager or investor can input aspects of the fashion design such as the different materials to use, the different sizes of the garment to make, the different colors for the garment, or any other aspect of the fashion design for which funds will be expended. The media management system 100 then assigns each aspect to a general aspect category so that users can search for requests for proposals. In this case, the media management system could assign the material for the fashion design to a category for garment manufacturing and also for garment material supplies. The media management system then posts each aspect on a virtual store web site which allows users to search for requests for proposals.

Users can then search the virtual store for different requests for proposal based on the category of the request for proposal. In addition, users can upload proposals to manufacture different aspects of the fashion design in response to the request for proposal. Once the responses are uploaded, the media management system 100 stores the information for each proposal in the project database 216 and stores the proposal in the media storage unit.

Once the proposals are stored in the project database 216, the media project manager or an investor can review the total cost of using different materials and manufacturers. In addition, the media project manager can create user surveys associated with the media project which solicit input from users as to the different aspects in the request for proposals. For example, a survey may include questions to determine the type of material to use in the manufacture of the fashion design or the highest price a user would pay for the fashion design. The results of the survey are quantified and are viewable by the media project manager and the investors. The media project manager and producers can then analyze the costs of the different aspects of the fashion design as they relate to user interest to make an informed decision concerning each aspect of the fashion project.

In another embodiment consistent with the present invention, the media project includes three dimensional representations of products to be manufactured. The three dimensional representations can be developed using any commercially available three dimensional modeling software including, but not limited to, Pro-E®, AutoCAD or any other three dimensional modeling software. The files associated with the three dimensional representations are stored in the media storage unit 214 in a format viewable by the commercially available media viewing software described previously.

As another illustrative example, the media comprises the programming code. Consistent with this embodiment, programmers may upload un-compiled computer programming code in any commercially available programming language, including but not limited to Visual Studio, HTML, PHP, Cobra, C++, Java or any other computer programming language. As an illustrative example of this embodiment, a programmer creates a media project and uploads media files depicting logical flow charts for the operation of a program. The flow charts can be developed using any commercially available flow chart software including, but not limited to Microsoft Visio, Open Office or any other flow chart software. Users of the media management 100 can modify the flow charts or programming code and upload the modifications to the media storage unit 214 using any of the methods previously discussed. In addition to the programming code, the media project manager, in this case the programmer, can also upload compiled software code.

As another illustrative example, the media project manager may upload flow charts representing business process. Consistent with this embodiment, users may download and upload the flow charts and make adjustments to the business processes. In addition, the media project manager may also solicit feedback from potential users of the business processes using the surveying portion described previously. As another illustrative example, the media project manager may upload a book or a portion of the book using any of the methods previously described. Consistent with this embodiment, the media project manager may review and accept edits of the book, conduct surveys on portions of the book or the story line and determine costs of publishing the book or portions of the book using any of the previously discussed methods. In addition, publishers may monitor the book to determine the popularity of book with different user's based on demographic data using any of the previously discussed methods.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A media management system including::
a media storage unit which stores a plurality of media files;
a media project information unit that includes a plurality of media projects and that associates at least one media file in the media storage unit with a media project in the media project information unit.;
a proposal unit that determines the cost to produce a media project based on the media files associated with the media project.

2. The media management system of claim 1 wherein the media storage unit stores both original media files and edited media files.

4. The media management system of claim 1, comprising a registration unit that grants users access to view and edit media files associated with a media project.

5. The media management system of claim 1 wherein the proposal unit associates a category for each media project based on the content of the media files associated with each media project.

6. The media management system of claim 5 wherein the proposal unit associates subcategories for each media project based on the content of the media files associated with each media project and the category associated with the media project.

7. The media management system of claim 5 wherein the proposal unit generates a list of aspects of the media project based on the category and sub-category associated with the media project.

8. The media management system of claim 5 wherein the proposal unit generates a request for proposal to produce the media project based on the aspects of the media project.

9. The media management system of claim 1 wherein the media storage unit stores text documents, and
the media project information unit associates each text document with at least one media file associate with the media project in the media storage unit.

10. A method of managing media production including: the steps of:
storing a plurality of media files in a media storage unit;
creating a media project in a media project information unit;
associating at least one media file in the media storage unit with a media project in the media project information unit.;
determining the cost to produce a media project based on the media files associated with the media project.

11. The media management system of claim 10 wherein the media storage unit stores both original media files and edited media files.

12. The media management system of claim 10, comprising the step of granting users access to view and edit media files associated with a media project by a registration unit.

13. The media management system of claim 10 wherein the proposal unit associates a category for each media project based on the content of the media files associated with each media project.

14. The media management system of claim 13 wherein the proposal unit associates subcategories for each media project based on the content of the media files associated with each media project and the category associated with the media project.

15. The media management system of claim 13 wherein the proposal unit generates a list of aspects of the media project based on the category and sub-category associated with the media project.

16. The media management system of claim 13 wherein the proposal unit generates a request for proposal to produce the media project based on the aspects of the media project.

17. The media management system of claim 10 wherein the media storage unit stores text documents, and
the media project information unit associates each text document with at least one media file associate with the media project in the media storage unit.
